(19) United States
(12) Patent Application Publication
(10) Pub. No.: US 2007/0156724 A1
(43) Pub. Date: Jul. 5, 2007

(54) DATABASE SYSTEM

(76) Inventors: Pekka Kostamaa, Santa Monica, CA (US); Bhashyam Ramesh, Secunderabad (IN)

Correspondence Address: James M. Stover;Intellectual Property Section, Law Department, NCR Corporation, 1700 South Patterson Blvd., Dayton, OH, 45479-0001, US

(21) Appl. No.: 11/608,278

(22) Filed: Dec. 8, 2006

Related U.S. Application Data
(60) Provisional application No. 60/751,611, filed on Dec. 19, 2005.

(51) Int. Cl. G06F 7/00

(52) U.S. Cl. 707/100

(57) ABSTRACT

FIG. 1 illustrates a database system 1 including a storage device 2. Device 2 stores table data 3 indicative of a plurality of rows 4. A source access module 5 is assigned to access one of rows 4, this particular row being designated by reference numeral 6. Module 5 is responsive to a command 7 for reading row 6 from device 2. Subsequently, module 5 writes row 6 to device 2 in a packet accessible by a target module 8, this packet presently taking the form of a shared spool file 9.

### FIELD OF THE INVENTION

The present invention relates to a database system. The invention has been primarily developed for efficient production and consumption of intermediate query results in a shared disk clique, and will be described by reference to that application. However, the invention is by no means restricted as such, and is generally applicable to database systems in a broader sense.

### BACKGROUND

Any discussion of the prior art throughout the specification should in no way be considered as an admission that such prior art is widely known or forms part of common general knowledge in the field.

Typically, a database system includes a storage device for maintaining table data made up of a plurality of rows. Access modules are provided for accessing the individual rows, usually with each row being assigned to one of the access modules. Each access module is initialized to access only those rows assigned to it. This may be zero, one, or more rows depending on the amount of data stored and hashing algorithms used. This assignment of rows to access modules facilitates the sharing of processing resources for efficient use of the database, and is common in systems that make use of Massively Parallel Processing (MPP) or clustered architectures. In known examples of such systems, actions such as row distribution and row duplication are relatively I/O intensive.

### SUMMARY

It is an object of the present invention to overcome or ameliorate at least one of the disadvantages of the prior art, or to provide a useful alternative.

In accordance with a first aspect of the invention, there is provided a database system including:
a storage device for storing table data indicative of a plurality of rows;
a source access module assigned to access one of the rows, the source module being responsive to a command for:
   reading the row from the storage device; and
   writing the row to the storage device in a packet accessible by a target access module.

Preferably the command is indicative of the target module. More preferably the command is either of:
a row redistribution command to redistribute the row to the target module; or
a row duplication command to duplicate the row to the target module.

In some cases the command is indicative of a plurality of target modules and the packet is accessible by the plurality of target modules.

Preferably a source node carries the source module and a target node carries the target module. More preferably node sharing of spools is enabled such that when a given module carried by a given node reads a spool, one or more further modules carried by that given node share a common memory copy of the spool. Typically the source and target nodes belong to a single clique. In a preferred embodiment clique sharing of spools is enabled such that a clique shared spool file is accessible by any module carried by any node in the clique.

Preferably the row is maintained in a source storage location of the storage device, the source storage location maintaining a portion of the table data assigned to the source node. More preferably the row is written to a shared storage location of the storage device, the shared storage location selectively maintaining one or more portions of the table data respectively assigned to one or more nodes of the system.

The storage device preferably includes a shared storage location for maintaining the packet.

In some embodiments the packet is a clique shared spool file accessible by the target module. In cases where the command is a row redistribution command, the clique shared spool file preferably maintains the row for consumption by the target module such that the row is redistributed to the target module. Preferably only the target module reads the clique shared spool file. In some circumstances there is a plurality of target modules and a clique shared spool maintaining the row is provided for each target module. In cases where the command is a row duplication command, the clique shared spool file preferably maintains the row for consumption by the target module such that the row is duplicated to the target module. In circumstances where there is a plurality of target modules and the clique shared spool file is available for consumption by each of the target modules such that the row is duplicated to each of the target modules.

According to a second aspect of the invention, there is provided a method for row redistribution in a database system, the method including the steps of:
reading the row from a source storage location using a source access module; and
writing the row to a second storage location using the source access module such that the row is accessible to a target access module thereby to redistribute the row to the target module.

According to a third aspect of the invention, there is provided a method for row duplication in a database system, the method including the steps of:
reading the row from a source storage location using a source access module; and
writing the row to a second storage location using the source access module such that the row is accessible to a plurality of target access modules thereby to duplicate the row to the plurality of target access modules.

According to a further aspect of the invention, there is provided a database system including:
a plurality of nodes for accessing data; and
a plurality of primary storage locations each for maintaining a portion of the data, each portion being maintained for access by a respective associated one of the nodes; and
a secondary storage location for selectively maintaining one or more portions of the data for access by a predetermined one or more of the nodes.

### BRIEF DESCRIPTION OF THE DRAWING

Benefits and advantages of the present invention will become apparent to those skilled in the art to which this invention relates from the subsequent description of exemplary embodiments and the appended claims, taken in conjunction with the accompanying drawings, in which:

FIG. 1 is a schematic representation of a database system according to the invention;

FIG. 2 is a further representation of the system of FIG. 1;

FIG. 3 is a more detailed representation of the system of FIG. 1;

FIG. 4 is a schematic representation of a known database system, showing a row redistribution procedure;

FIG. 5 is a flowchart showing for the procedure shown in FIG. 4;

FIG. 6 is a schematic representation of a the system of FIG. 1, showing a row redistribution procedure;

FIG. 7 is a flowchart showing for the procedure shown in FIG. 6;

FIG. 8 is a schematic representation of a known database system, showing a row duplication procedure;

FIG. 9 is a flowchart showing for the procedure shown in FIG. 8;

FIG. 10 is a schematic representation of a the system of FIG. 1, showing a row duplication procedure; and

FIG. 11 is a flowchart showing for the procedure shown in FIG. 10.

### DETAILED DESCRIPTION

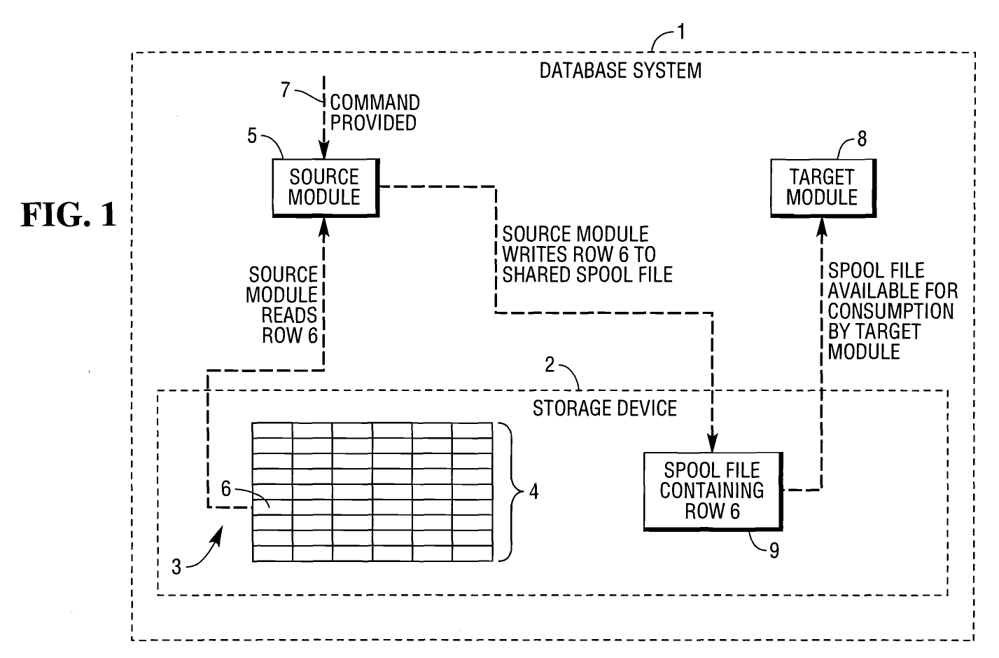

FIG. 1 illustrates a database system 1 including a storage device 2. Device 2 stores table data 3 indicative of a plurality of rows 4. A source access module 5 is assigned to access one of rows 4, this particular row being designated by reference numeral 6. Module 5 is responsive to a command 7 for reading row 6 from device 2. Subsequently, module 5 writes row 6 to device 2 in a packet accessible by a target module 8, this packet presently taking the form of a shared spool file 9.

In the present embodiment, the assignment relationship between module 5 and row 6 is one-way exclusive. That is, row 6 is accessed only by module 5. On the other hand, module 5 is—or is at least able to be—assigned to access another one or more rows 4. For the purpose of this disclosure, the terms “a module assigned to access a row” and “a row assigned to a module” are used interchangeably.

Although FIG. 1 shows data 3 in the form of a single table, this is not to imply any existing physical arrangement. Typically, rows 4 of a particular database table are stored at separate locations within device 2. Generally speaking, each row is assigned to an access module such that the total number of existing rows is shared among the modules to allow efficient row access. Embodiments of the present invention are directed towards situations where row 6 is assigned to module 5, and hence not accessible by module 8. The underlying purpose of system 1 in such an embodiment is to provide a procedure by which row 6 is made available to module 8, this enabling row redistribution and row duplication. This is primarily achieved by module 5 writing shared spool file 9 to device 2.

The terms “redistribution” and “duplication” should be read broadly for the purposes of this disclosure to include notions of “effective” or “functional” redistribution or duplication. That is, there is not direct need for a row to be physically redistributed or duplicated, only that the row be dealt with in such a matter to provide effective redistribution or duplication. This is particularly relevant in relation to shared spool file 9.

Consider duplication. This term typically denotes a row being duplicated to all the target modules. In the present case, a row is instead made accessible to all the target modules, as discussed in greater detail below. There is actually no physical duplication of the row in the conventional sense. However, the effect is that of duplicating the row, as requested by command 7. That is, the row is “effectively” or “functionally” duplicated.

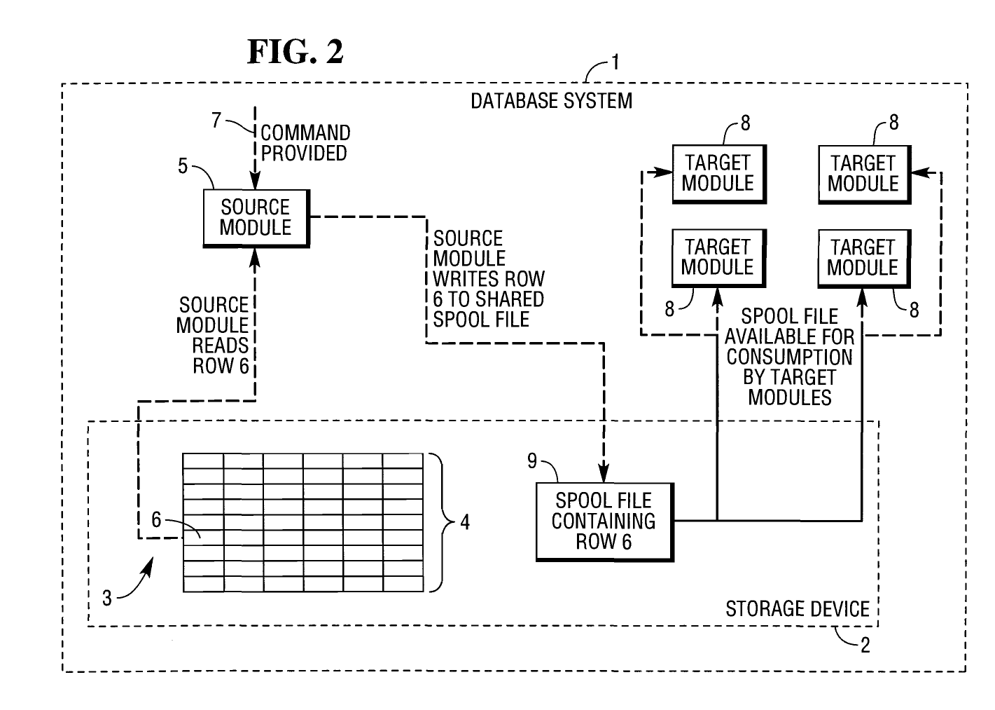

Command 7 is indicative of module 8 to identify module 8 as a target module. More precisely, command 7 identifies the column or columns from row 6 that are to be hashed. The associated hash value then identifies target module 8. That is, at least in some embodiments, the target module is not directly identified in the command. For example: where command 7 is a row redistribution command to redistribute row 6 to module 8. In this case, module 8 is referenced to identify it as being a redistribution target. In some cases, command 7 is indicative of a plurality of target modules 8, and packet 9 is accessible by this plurality of modules—as shown in FIG. 2. This is common where command 7 is a row duplication command to duplicate row 6 to the plurality of modules 7. Typically a query dispatcher provides command 7, although various database components provide such commands among embodiments. In a general case, command 7 includes three basic details:
Where to read the row.
What to do with the row—typically some kind of operation such as join, scan, aggregate, and so on.
What to do with the resulting row.

The present system is most concerned with the last of these, and most particularly where, and how, to place the resulting row.

Although redistribution and duplication commands are dealt with primarily, the functionality of system 1 extends to intermediate steps in a broader sense. It will be appreciated that, generally speaking, intermediate steps in the execution of a query typically produce respective intermediate results, which are containable in a spool 9.

Generally speaking, a query is received in system 1, and this query is optimized using an optimizer. This generates an execution plan typically including a number of intermediate steps. The results of intermediate steps are maintained within spool files and passed between steps. It is common for an intermediate step to involve a join. Joining is typically achieved by either redistribution or duplication. An example is set out below.

Assume the following query description and associated SQL statement:

“Find all suppliers who are also customers and have made at least one order over $5,000.”
SELECT s_suppkey, s_name, s_phone
FROM supplier, customer, ordertbl
WHERE s_name=c_name AND s_phone=c_phone
AND c_custkey=o_custkey and o.total_price>5000

Also assume the following cardinalities:

‘supplier’ and ‘customer’ are medium sized tables

‘ordertbl’ is a large table

A large number of orders have a total_price>5000

Only a very small fraction of customers are also suppliers

Given below is a likely execution plan that would be chosen by an optimizer:
Step #A1—Retrieve ordertbl rows with total_price>5000 and store result in spool #1.
Step #A2—Join customer and supplier and store result in spool #2.
Step #A3—Sort both spools on their respective joining columns and join them using a merge-join algorithm.

In relatively simple terms, Step #A1 would likely store the resulting spool #1 locally, sorted by o_custkey. Step #A2 requires first a redistribution of both the supplier and customer rows by hashing the name and phone columns. The resulting spool file from this join could then be duplicated, and sorted by c_custkey. Step #A3 would not require any redistribution on duplication.

Throughout the present disclosure, system 1 is described by reference to a particular clustered MPP architecture based around a MPP architecture used in known Teradata® database systems. Those skilled in the art will understand and readily implement other embodiments making use of alternate architectures. In particular: other clustered architectures. Teradata is a trademark of NCR Corporation.

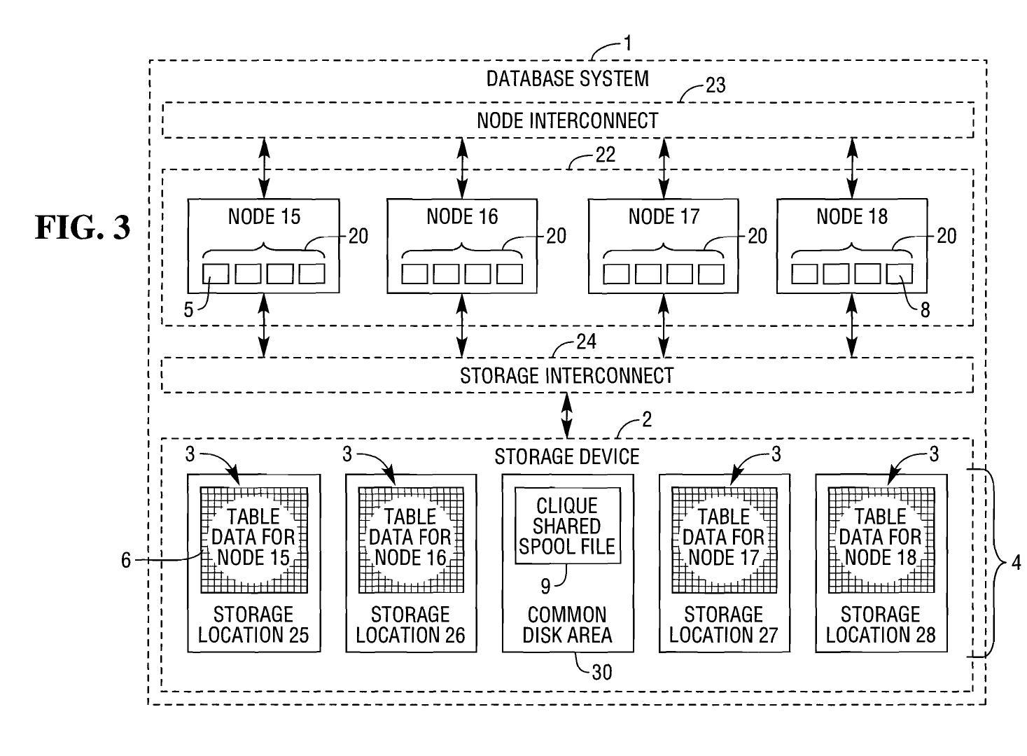

FIG. 3 illustrates system 1 in greater detail. System 1 includes a plurality of nodes 15 to 18. Each node 15 to 18 carries four access modules, generically designated by reference numeral 20. In particular, node 15 carries module 5 and node 18 carries module 8. Nodes 15 to 18 collectively define a clique 22. A node interconnect 23 is provided to enable communication between the nodes.

Those skilled in the art will understand a clique to be a set of processing nodes that have access to shared I/O devices. In other embodiments the nodes define a cluster. A cluster is typically similar to a clique, although a cluster generally does not provide multiple paths to the storage device.

It will be appreciated that modules 5 and 8 are chosen indiscriminately and for the sake of illustration, and any pair of modules 20 are appropriate. However, it will be appreciated that the disclosed duplication and redistribution functionality is most applicable to modules held on different nodes.

Device 2 is defined by a plurality of individual disks, which are not shown for the sake of simplicity in illustration. A disk interconnect 24 provides a clique-type cross connection between the nodes and the disks such that any of the nodes is able to communicate with any of the disks. This has particular benefits in managing risks associated with Mean Time Between Failures (MTBF).

Device 2 includes a plurality of individual storage locations 25 to 28, functionally defined by the table data 3 they each hold. Specifically, a storage location 25 to 28 is provided for maintaining table data associated with each of nodes 15 to 18 respectively. For example: location 25 maintains table data 3 indicative of rows 4 assigned to those modules 20 carried by node 15. It will be appreciated that this includes row 6.

The assignment of rows 4 to modules 20 is primarily based on a hashing protocol. Those skilled in the art will understand the practical reasons for such approach, particularly from a query response time perspective. The individual hashing protocols used are beyond the scope of the present disclosure, however it is noted that rows of a single database table are typically distributed across some or all of locations 25 to 28.

Those skilled in the art will understand how spool files are used in known database systems to facilitate row redistribution and duplication. In particular, spool files are transferred between processing modules through a node interconnect—such as interconnect 23. That is, a spool file is written to the interconnect by a sender module, and subsequently read from the interconnect by a recipient module. This recipient module then writes the row or rows included in the spool file to disk.

In system 1, spool files are written directly to storage device 2 by modules 20. More specifically, they are written to a further storage location of device 2, in the form of a common disk area (CDA) 30. As such, CDA 30 maintains one or more portions of the data 3 respectively assigned to one or more nodes 15 to 18 of system 1.

In the present embodiment, node sharing of spools is enabled such that when a given module 20 carried by a given node reads a spool such as spool 9, one or more further modules carried by that given node share a common memory copy of that spool. Clique sharing of spools is also enabled such spool 9 is accessible by any module in the clique. Whether a particular module actually accesses a particular spool is determined by the row or rows contained within the spool file.

In some embodiments CDA 30 is defined on or indeed defines a single physical disk, however in other embodiments it is shared across one or more individual disks. Given the clique type connection provided by interconnect 24 either option is feasibly appropriate. From a strictly definitional standpoint, CDA 30 is functionally defined by a region of device 2 that maintains one or more spools such as spool 9.

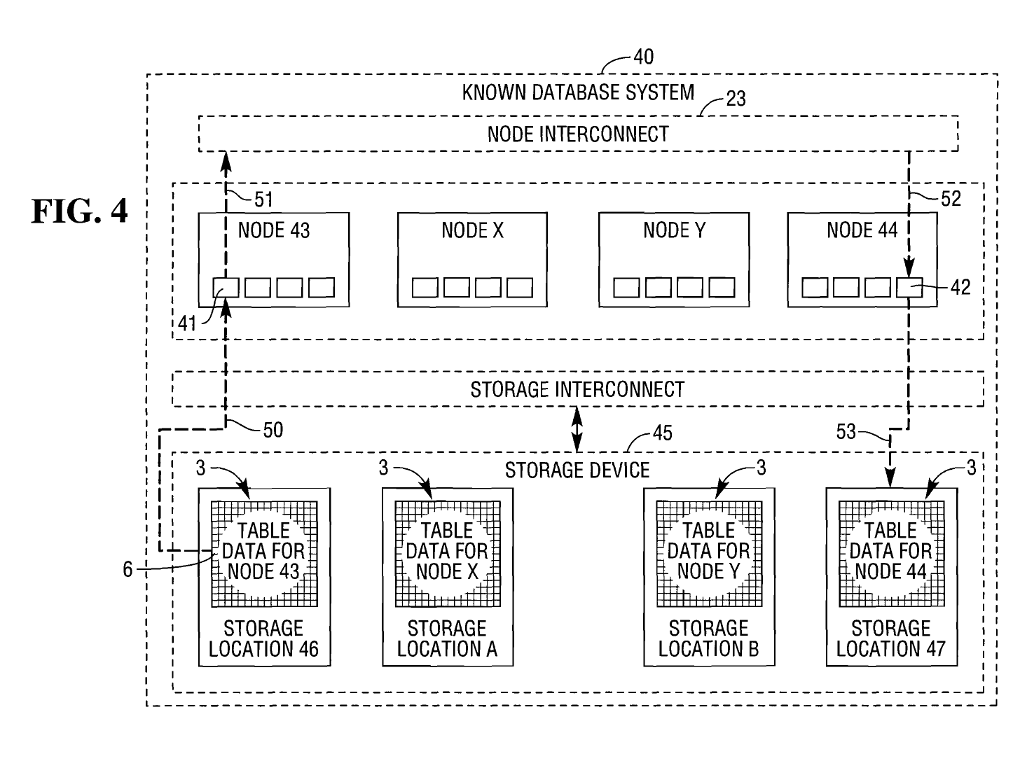

The use of clique shared spool files, such as spool 9, facilitates a reduction in I/O consumption when compared to prior art systems. This is explained in greater detail below by reference to FIGS. 4 to 7. In each of these figures, a dashed line represents an individual I/O.

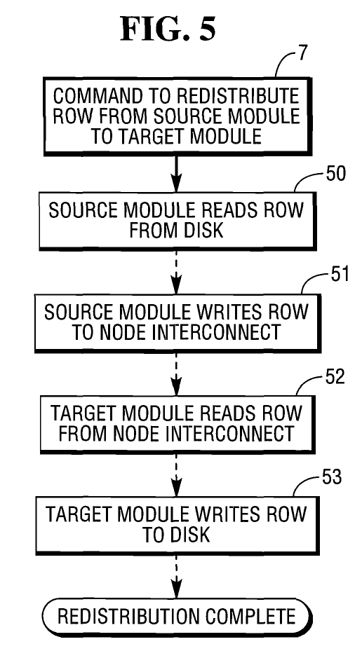

FIG. 4 illustrates a known database system 40. System 40 includes the same data 3 as system 1—in particular row 6. FIGS. 4 and 5 illustrate a typical process for redistributing row 6 from a first module 41 to a target module 42, respectively carried by nodes 43 and 44. The nodes are connected by a node interconnect 23. System 40 includes a storage device 45 having a location 46 for maintaining node 43 table data (including row 6) and a location 47 for maintaining node 44 table data.

A command 7 is received, this command requiring redistribution of row 6 to module 42. First, module 41 reads row 6 from location 46 at 50. Module 41 then writes row 6 to interconnect 23 at 51. Module 42 reads row 6 from interconnect 23 at 52. Finally, module 42 writes row 6 to location 47 at 53. It will be recognized that this known procedure involves four I/Os.

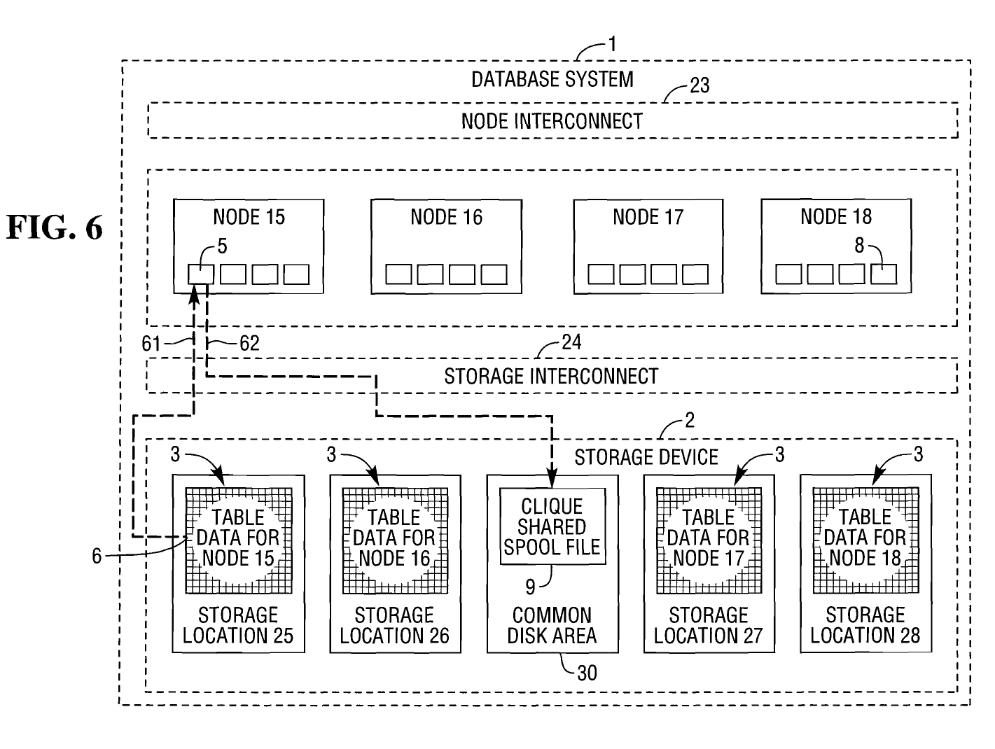

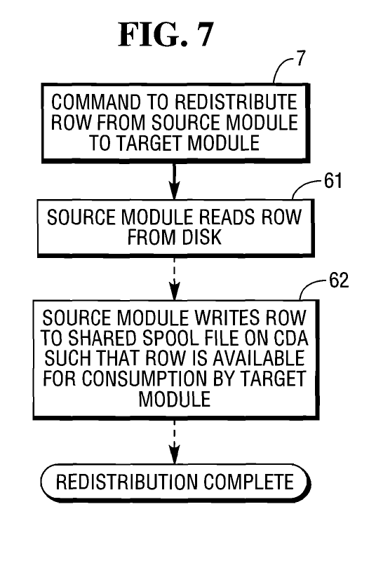

FIGS. 6 and 7 illustrate a procedure 60 followed by system 1 on the basis of a similar redistribution command 7. This procedure involves only two I/Os: a first at 61 where module 5 reads row 6 from location 25, and a second at 62 where module 5 writes spool 9 to CDA 30. Spool 9 is maintained on CDA 30 for consumption by module 8. This effectively redistributes row 6 to module 8. Procedure 60 is referred to as “disk-based redistribution” for the sake of the present disclosure.

For disk-based redistribution, only a receiving target module 8 reads spool 9. However, all modules 20 are enabled to write to spool 9. As such, a plurality of rows 4 are conveniently redistributed to a single target module 8 by a sending selection of modules 20 using a single spool 9 and requiring only two I/Os per row.

For disk-based redistribution of a table, there are likely to be a plurality of target modules 8. In this case, one spool 9 is provided for each target module 8.

It will be recognized that disk based redistribution often results in a 50% reduction in I/O consumption when compared to prior art redistribution techniques.

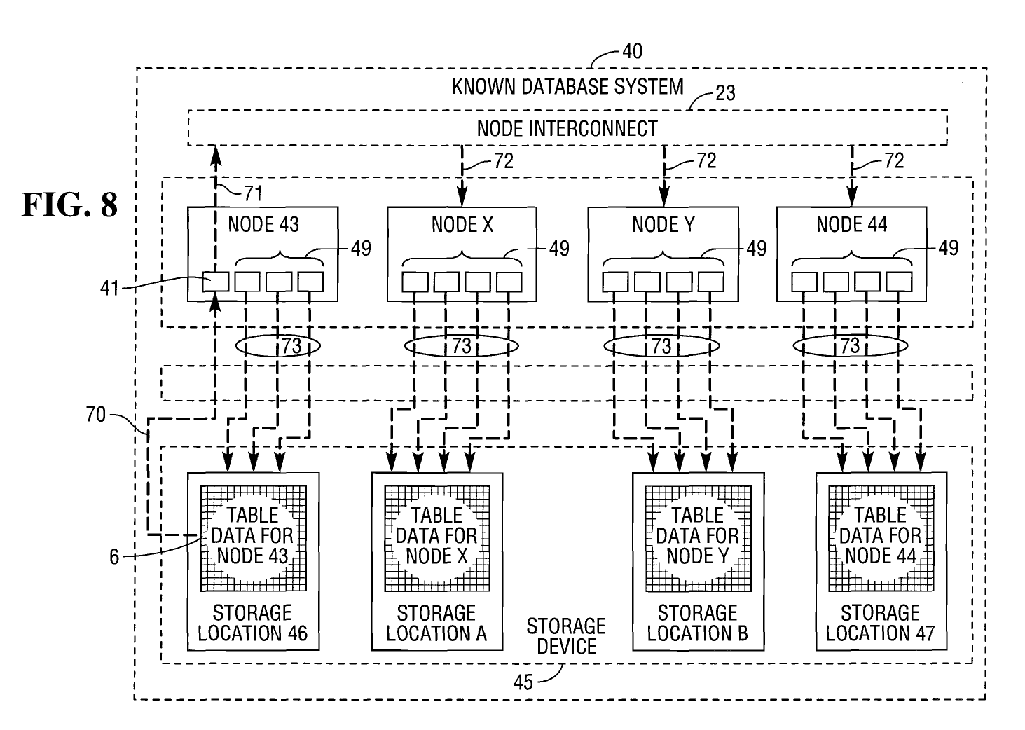

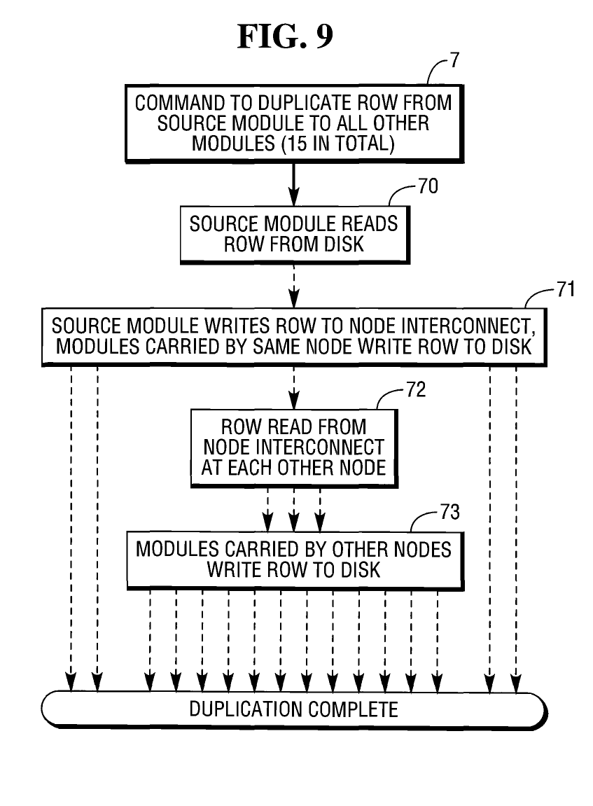

FIGS. 8 and 9 illustrate a duplication procedure followed by known database system 40. This procedure is based upon a command 7 to duplicate row 6 from module 41 to all remaining modules 49.

First, module 41 reads row 6 from location 46 at 70. Module 41 then writes row 6 to interconnect 23 at 71, and the modules 49 carried by that node 43 write row 6 to disk. Row 6 is written in broadcast form such that it is subsequently read by all modules 49 not carried by node 43 at 72, however typically only one I/O is incurred for each node. Modules 49 carried by node 43 have access to row 6 following the read by module 41. All of modules 49 then individually write row 6 to disk at 73, resulting in fifteen I/Os in this example. The total number of I/Os is twenty. More generically, the number of I/Os is equal to the number of nodes plus the number of modules.

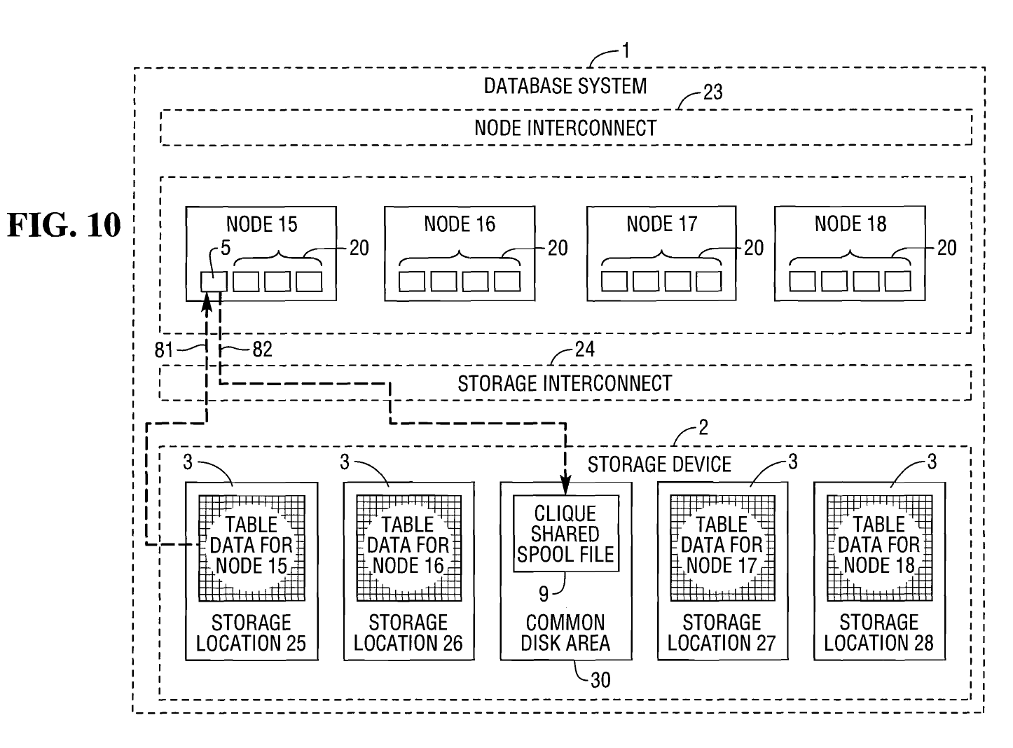

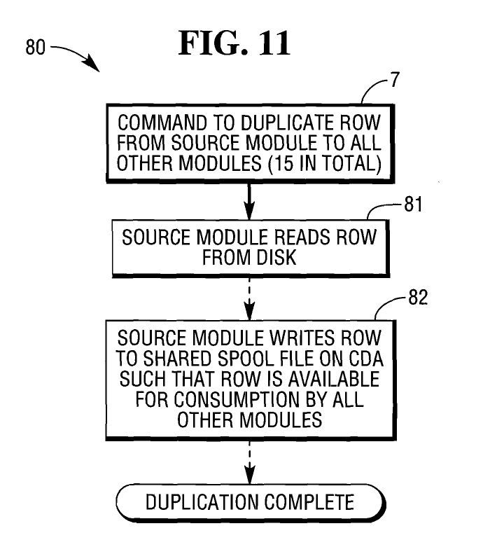

FIGS. 10 and 11 illustrate a procedure 80 for disk based duplication utilized by system 1. Procedure 80 is based around a command 7 similar to that provided for FIGS. 6 and 7. As was the case with redistribution, procedure 80 involves only two I/Os: a first at 81 where module 5 reads row 6 from location 25, and a second at 82 where module 5 writes spool 9 to CDA 30. Spool 9 is maintained on CDA 30 for consumption all other modules 20. This effectively duplicates row 6 to modules in the clique.

For disk-based duplication, all modules 20 are effectively target modules, and each of these reads spool 9. As with redistribution, all modules 20 are enabled to write to spool 9.

It will be recognized that disk based duplication results in a considerable reduction in I/O consumption when compared to prior art duplication techniques.

From the above disclosure of procedures 60 and 80, it will be appreciated that system 1 provides a more efficient usage of I/O as compared with known database systems that make use of similar architecture, such as system 40. This allows for less resource intensive and more time effective duplication and redistribution of rows. The net result is efficient production and consumption of intermediate query results in a shared disk clique.

Although the present invention has been described with particular reference to certain preferred embodiments thereof, variations and modifications of the present invention can be effected within the spirit and scope of the following claims.

What is claimed is:

1. A database system including:
a storage device for storing table data indicative of a plurality of rows;
a source access module assigned to access one of the rows, the source module being responsive to a command for:
reading the row from the storage device; and
writing the row to the storage device in a packet accessible by a target access module.

2. A system according to claim 1 wherein the command is indicative of the target module.

3. A system according to claim 2 wherein the command is either of:
a row redistribution command to redistribute the row to the target module; or
a row duplication command to duplicate the row to the target module.

4. A system according to claim 2 wherein the command is indicative of a plurality of target modules and the packet is accessible by the plurality of target modules.

5. A system according to claim 1 wherein a source node carries the source module and a target node carries the target module.

6. A system according to claim 5 wherein node sharing of spools is enabled such that when a given module carried by a given node reads a spool, one or more further modules carried by that given node share a common memory copy of the spool.

7. A system according to claim 5 wherein the source and target nodes belong to a single clique.

8. A system according to claim 7 wherein clique sharing of spools is enabled such that a clique shared spool file is accessible by any module carried by any node in the clique.

9. A system according to claim 5 wherein the row is maintained in a source storage location of the storage device, the source storage location maintaining a portion of the table data assigned to the source node.

10. A system according to claim 9 wherein the row is written to a shared storage location of the storage device, the shared storage location selectively maintaining one or more portions of the table data respectively assigned to one or more nodes of the system.

11. A system according to claim 1 wherein the storage device includes a shared storage location for maintaining the packet.

12. A system according to claim 1 wherein the packet is a clique shared spool file accessible by the target module.

13. A system according to claim 12 wherein the command is a row redistribution command and the clique shared spool file maintains the row for consumption by the target module such that the row is redistributed to the target module.

14. A system according to claim 13 wherein only the target module reads the clique shared spool file.

15. A system according to claim 14 wherein there is a plurality of target modules and a clique shared spool maintaining the row is provided for each target module.

16. A system according to claim 12 wherein the command is a row duplication command and the clique shared spool file maintains the row for consumption by the target module such that the row is duplicated to the target module.

17. A system according to claim 16 wherein there is a plurality of target modules and the clique shared spool file is available for consumption by each of the target modules such that the row is duplicated to each of the target modules.

18. A method for row redistribution in a database system, the method including the steps of:
reading the row from a source storage location using a source access module; and
writing the row to a second storage location using the source access module such that the row is accessible to a target access module thereby to redistribute the row to the target module.

19. A method for row duplication in a database system, the method including the steps of:
reading the row from a source storage location using a source access module; and
writing the row to a second storage location using the source access module such that the row is accessible to a plurality of target access modules thereby to duplicate the row to the plurality of target access modules.

20. A database system including:
a plurality of nodes for accessing data; and
a plurality of primary storage locations each for maintaining a portion of the data, each portion being maintained for access by a respective associated one of the nodes; and
a secondary storage location for selectively maintaining one or more portions of the data for access by a predetermined one or more of the nodes.
